(19) United States
(12) Patent Application Publication
(10) Pub. No.: US 2024/0144842 A1
(43) Pub. Date: May 2, 2024

(54) DECK OF PLAYING CARDS AND METHODS OF PLAY

(71) Applicant: Herbert Marshall, Wheatland, WY (US)

(72) Inventor: Herbert Marshall, Wheatland, WY (US)

(21) Appl. No.: 18/051,082

(22) Filed: Oct. 31, 2022

(51) Int. Cl. G09B 19/22; A63F 1/02

(52) U.S. Cl. CPC G09B 19/22; A63F 1/02; A63F 2001/027

(57) ABSTRACT

A deck of playing cards includes a plurality of main cards having an identical rear face. Each main card has a front face indicating a card value, a suit, a point value, and one of a plurality of territorial regions. The territorial regions may include the fifty states, the District of Columbia, and overseas territories. The combination of card value and suit uniquely identifies each main card. The territorial region also uniquely identifies each main card. The point value may equal the number of electoral-college votes either cast by, or allocated to, the territorial region when the territorial region is one of the fifty states or the District of Columbia. Each card may also indicate on its front face information about the territorial region, such as an insignia, flag, motto, or nickname. Two games that may be played with the deck are White House and Statehood.

### BACKGROUND

Games are used for entertainment, learning, and interacting with others, among other purposes. In particular, games that use playing cards are advantageous in that they are usually smaller than many other types of non-electronic games (e.g., board games) and therefore can be easily packed for travel. Many card games are played with a standard deck of fifty-two playing cards consisting of four standard suits (i.e., spades, clubs, hearts, and diamonds) and thirteen standard card values (i.e., 2, 3, 4, 5, 6, 7, 8, 9, 10, Jack, Queen, King, and Ace). Card games using the standard deck include various forms of solitaire, i.e., games that can be played by only a single person. Other card games using the standard include are multi-player games that can be played by two or more players, either individually or as teams.

### SUMMARY

The present embodiments include playing cards, games that can be played with these playing cards, and electronic versions thereof. In certain embodiments, the playing cards are similar to conventional playing cards in that each is uniquely identified by a combination of one of the four standard suits and one of the thirteen standard card values. In these embodiments, there may be fifty-two playing cards to a deck, similar to a standard deck of playing cards. However, each playing card differs from a conventional playing card in that it is also uniquely identified by a territorial region that is displayed on its front face with the suit and card value.

In some embodiments, the territorial region is selected from a plurality of territorial regions forming the United States of America. This plurality of territorial regions may include, for example, the fifty states, the District of Columbia, and overseas territories (e.g., Puerto Rico, Samoa, the Virgin Islands, the Northern Mariana Islands, Guam, etc.). However, other territorial regions may be used, such as countries (e.g., countries in Africa, countries that belong to the European Union, countries that belong to NATO, etc.), counties within a particular state or country (e.g., the 64 counties in the state of Colorado, the counties of Ireland, etc.), US congressional districts, provinces, municipalities, and electoral districts or wards within a municipality (e.g., the 33 local government districts of Greater London, the 51 council districts of New York City, etc.). The plurality of territorial regions may be any other type of electoral subdivision, political entity, or geographic entity without departing from the scope hereof.

Each playing card also differs from a conventional playing card in that the territorial region has an associated point value that is displayed on the front face of the playing card. When the territorial region is a state or the District of Columbia, this point value may be the number of electoral votes either cast by the territorial region in a previous United States (US) presidential election or allocated to the territorial region for a future US presidential election. For all other territorial regions (i.e., overseas territories), the point value may be the number of electoral votes that would be cast by the territorial region if it were to participate in the US Electoral College (e.g., based on its population).

In some embodiments, all hearts and diamonds are associated with red, the color of the Republican party in the United States. Similarly, all clubs and spades are associated with blue, the color of the Democratic party in the United States. In some of these embodiments, the territorial regions are assigned to the suits such that each territorial region that voted for a particular political party's nominee in a past presidential election, or that is expected to vote for a particular political party's nominee in a future presidential election, is assigned to a suit having the color associated with the political party.

The features that differentiate the playing cards herein from conventional playing cards allow for new games to be created. Advantageously, these new games can have rules, actions, and methods of play that cannot be implemented with a standard deck of playing cards. Disclosed herein are two such games. The first, named “White House”, is a trick-taking game played by four players, either in partnership or individual play. The second, named “Statehood”, is an individual point-scoring game that can be played by two, three, or four players.

In addition to entertainment, the playing cards herein may be used to educate players about the United States and the workings of the US government. For example, the game of White House may be used to teach players how the US Electoral College works and how the two main US political parties use the rules of the US Electoral College to strategize for US presidential elections. Similarly, the game of Statehood may be used to teach players how new states are admitted to the Union (as the name of this game implies). Regardless of the game, each playing card may be used to teach players one or more facts about the territorial region displayed thereon. Such facts include, but are not limited to, an insignia, a color, a flag, a seal, a coat of arms, a founding date, a motto, a nickname, and a state symbol (e.g., state bird, state tree, state flower, state flora, state fauna, state geology item, state cultural item, etc.).

The present embodiments also include electronic versions of these playing cards and games thereof. In one embodiment, a computing device includes a processor, a memory in electronic communication with the processor, and a graphical display in communication with the processor. The memory stores machine-readable instructions that, when executed by the processor, control the computing device to display, on the graphical display, an image of any playing card of the present embodiments. The memory may store additional machine-readable instructions that, when executed by the processor, control the computing device to implement any card game that uses these playing cards. In one embodiment, the game is White House. In another embodiment, the game is Statehood.

In embodiments, a deck of playing cards includes a plurality of main cards having an identical rear face. Each main card of the plurality of main cards has a front face that indicates a card value selected from a plurality of card values, a suit selected of a plurality of suits, a territorial region selected from a plurality of territorial regions, and a point value. In some embodiments, the plurality of territorial regions include the fifty states of the United States of America, the District of Columbia, and at least one United States overseas territory. The combination of the card value and the suit uniquely identifies said each main card among the plurality of main cards. The territorial region also uniquely identifies said each main card among the plurality of main cards.

### BRIEF DESCRIPTION OF THE FIGURES

FIG. 1 shows the front face of a playing card, in an embodiment.

FIG. 2 shows front faces of a plurality of main cards that are hearts, in an embodiment.

FIG. 3 shows front faces of a plurality of main cards that are diamonds, in an embodiment.

FIG. 4 shows front faces of a plurality of main cards that are spades, in an embodiment.

FIG. 5 shows front faces of a plurality of main cards that are clubs, in an embodiment.

FIG. 6 shows front faces of wild cards, in an embodiment.

FIG. 7 shows front faces of jokers, in an embodiment.

FIG. 8 is a functional diagram of a computing device that electronically implements playing cards of the present embodiments.

FIG. 9 is a functional diagram of a networked computer system that electronically implements playing cards of the present embodiments.

### DETAILED DESCRIPTION

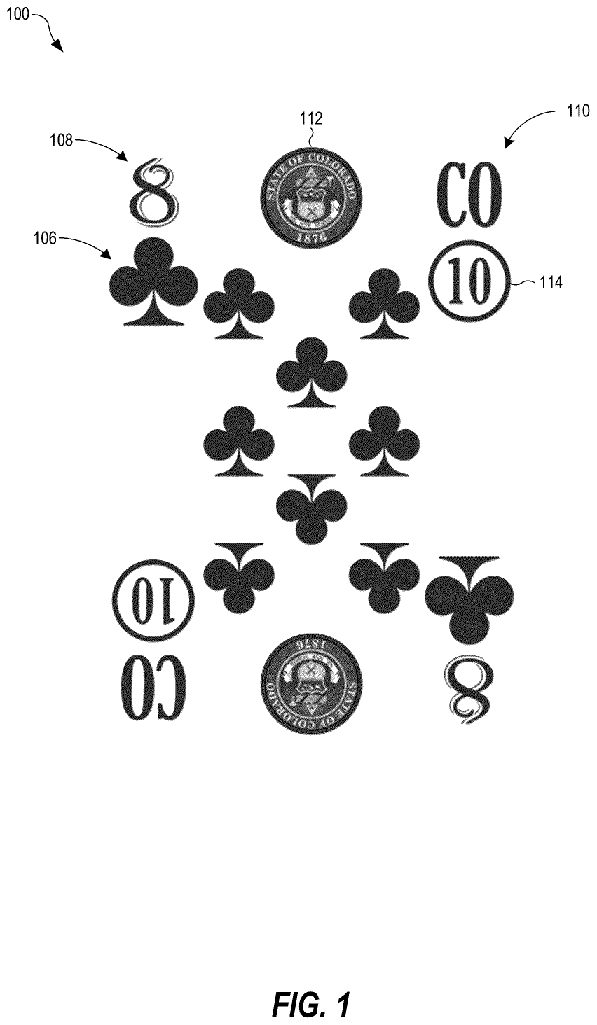

FIG. 1 shows the front face of a playing card 100. The playing card 100 is part of a deck of playing cards and is identified within the deck by a unique combination of a suit 106 and card value 108. The suit 106 is one of a plurality of suits represented throughout the deck. In the example of FIG. 1, the suit 106 is spades. In the following discussion, the suit 106 is one of the four standard suits used in a conventional deck of playing cards: hearts, spades, clubs, and diamonds. However, the deck may have additional or alternative suits. Similarly, it is not necessary that the deck use only four suits. Accordingly, the deck may have more than four suits or fewer than four suits.

The card value 108 is one of a plurality of card values represented throughout the deck of playing cards. In the example of FIG. 1, the card value is an eight. In the following description, the card value 108 is one of the thirteen standard card values used in a conventional deck of playing cards: 2, 3, 4, 5, 6, 7, 8, 9, 10, Jack, Queen, King, and Ace. However, the deck may have additional or alternative card values. Similarly, it is not necessary that the deck use only thirteen card values. Accordingly, the deck may have more than thirteen card values or fewer than thirteen card values.

The playing card 100 is also uniquely identified in the deck by a territorial region 110 that is displayed on the front face. The territorial region 110 is one a plurality of territorial regions. When the territorial region is a state or territory of the United States (US), the territorial region 110 may be represented by the two-letter abbreviation of the state or territory. For example, in FIG. 1 the territorial region 110 is “CO” to indicate the state of Colorado. The territorial region 110 may alternatively be the full name of the state or territory or another indicia of the state or territory (e.g., see discussion below about information 112). In some embodiments, the plurality of territorial regions includes all fifty states, the District of Columbia, and one or more US overseas territories (e.g., Samoa, Guam, Puerto Rico, US Virgin Islands, Northern Mariana Islands, etc.).

The front face of the playing card 100 also displays a point value 114. As shown in FIG. 1, the point value 114 may be circled to enhance visibility. Furthermore, the point value 114 may be located near the territorial region 110 to clarify an association between the two, as shown in FIG. 1. When the territorial region 110 is a voting participant of the US Electoral College (i.e., one of the fifty states and the District of Columbia), the point value 114 may be the number of electoral votes either previously cast by, or allocated to, the territorial region 110 in a US presidential election. The number of electoral votes may be the number of electoral votes in the 2020 US presidential election or a different US presidential election. For example, in FIG. 1 the point value 114 of “10” equals the number of electoral votes allocated to the state of Colorado for the 2024 US presidential election. For a state that does not use party block voting (i.e., Maine and Nebraska), the point value 114 may be the total number of electoral votes allocated to the entire state or a subset thereof.

When the territorial region 110 is not a voting participant in the US Electoral College (e.g., Puerto Rico), the point value 114 may be the number of electoral votes that would be cast by the territorial region 110 if it were a voting participant in the US Electoral College (e.g., as based on the population of an overseas territory). However, the point value 114 may be assigned or determined in a different manner without departing from the scope hereof, regardless of whether the territorial region 110 is a state, territory, or another type of entity.

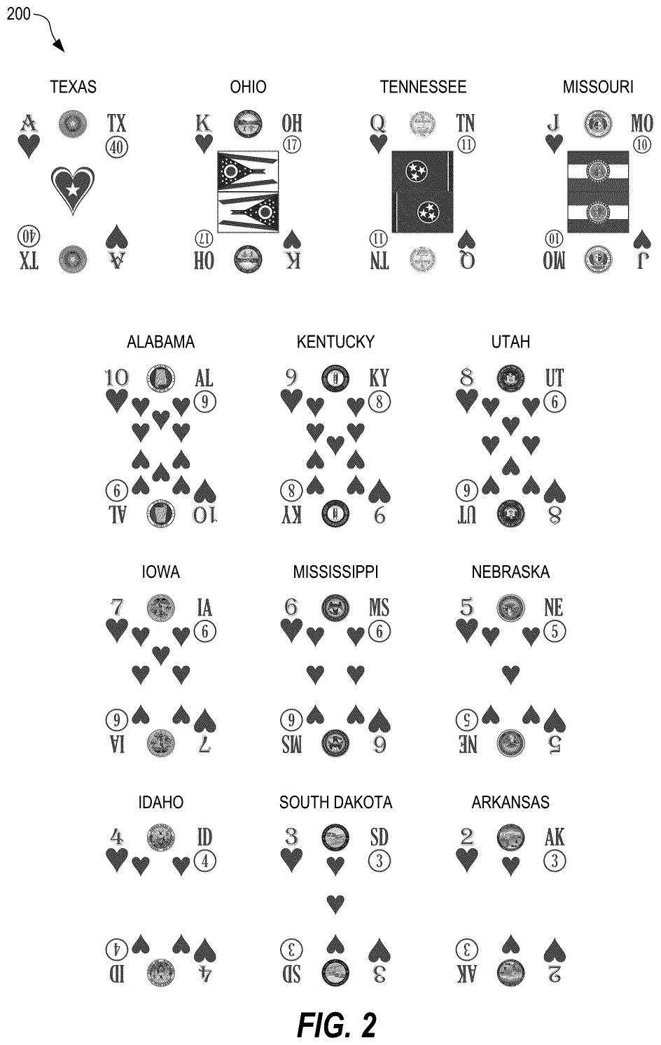

The front face of the playing card 100 also displays information 112 about the territorial region 110. In FIG. 1, the information 112 is the state seal of the state of Colorado. The information 112 may additionally or alternatively include one or more of: an insignia, a color, a flag (e.g., see the Kings, Queens, and Jacks in FIGS. 2-5), a coat of arms, a founding date, a motto, a nickname, flora, fauna, a bird, a dance, a poem, a food, a mineral, a gemstone, a license plate design, a musical instrument, a sport, a toy, a quarter (e.g., a statehood quarter) or other type of currency, a tartan, demographic information, historical information, geographic information, and government information. The information 112 may include any other information about the territorial region 110 without departing from the scope hereof.

As shown in FIG. 1, some of the indicia (i.e., the suit 106, card value 108, territorial region 110, point value 114, and information 112) may be displayed twice on the front face of the playing card 100 such that it is readable regardless of which way the playing card 100 is held. When the card value 108 is a number, the front face of the playing card 100 may repeat the symbol of the suit 106 by the number. For example, in FIG. 1, where the card value 108 is “8” and the suit 106 is clubs, the front face displays eight clubs symbols near the center of the card. Some of these eight clubs symbols are inverted to improve readability regardless of the which way the playing card 100 is held. In another embodiment, the front face displays the information 112 repeated by the point value 114. For example, the front face may display the state seal of Colorado ten times instead of displaying the eight clubs symbols.

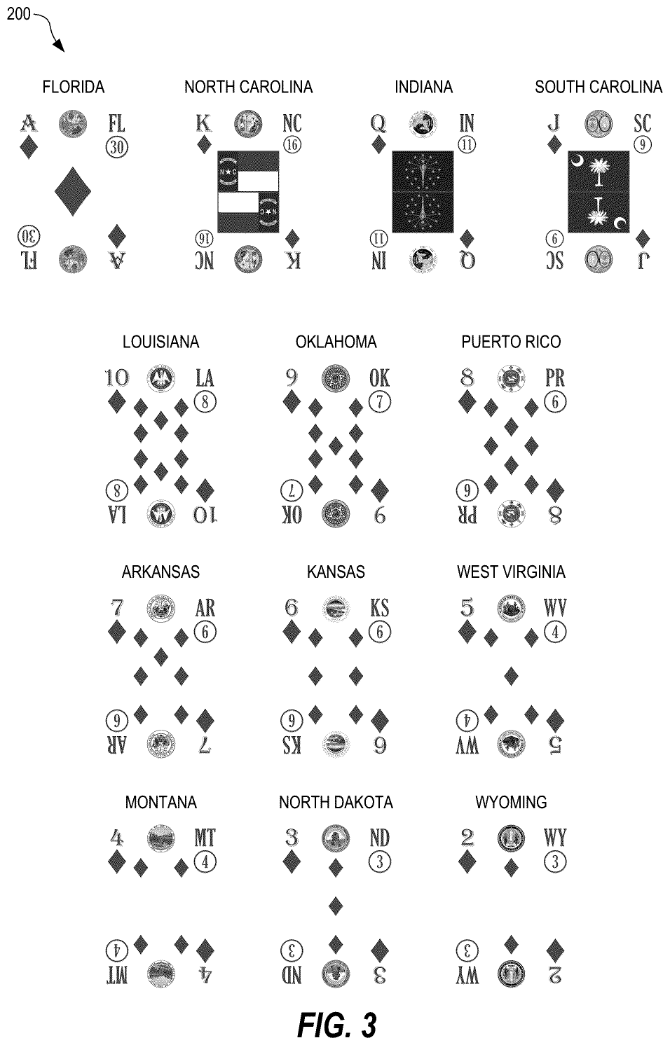

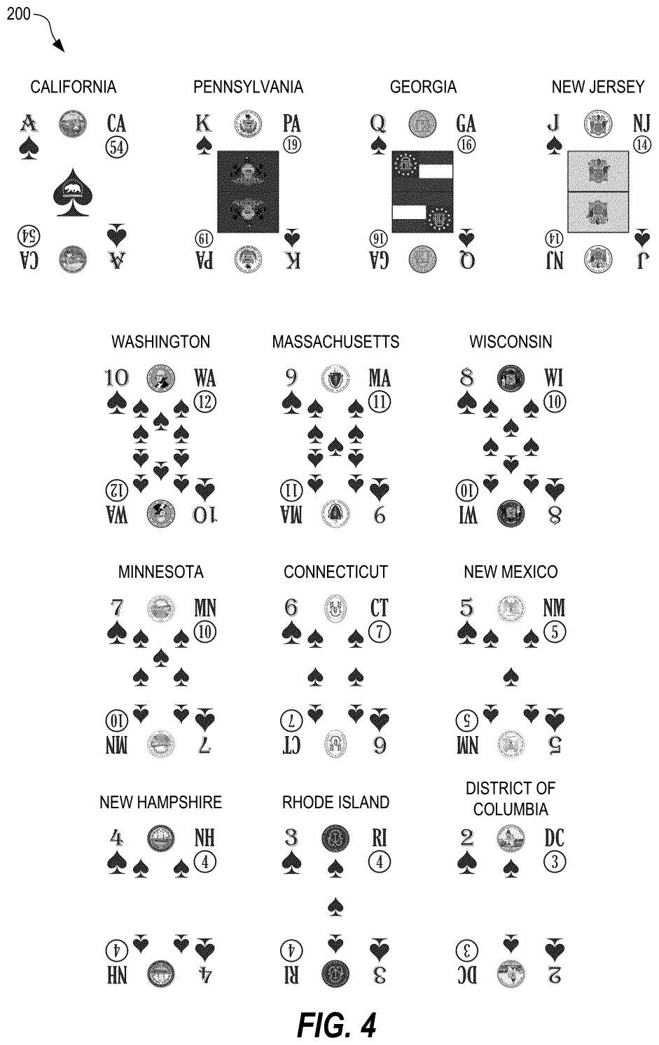

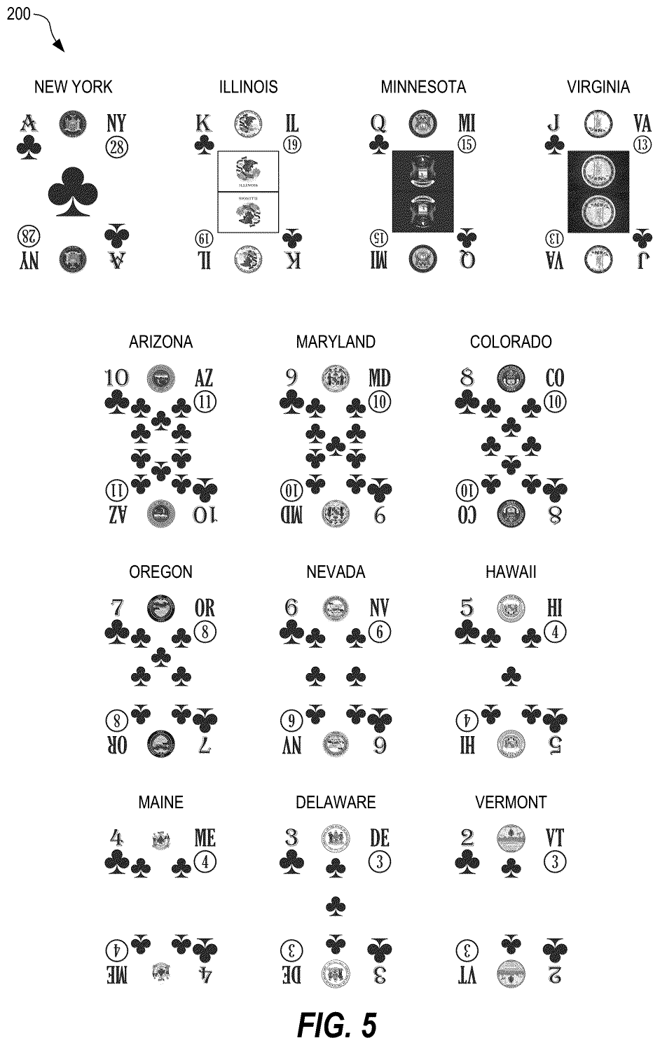

FIGS. 2-5 show front faces of a plurality of main cards 200 of the deck of playing cards. The playing card 100 of FIG. 1 is an example of one of the main cards 200. FIGS. 2-5 show the main cards 200 grouped by suit. Specifically, FIG. 2 shows main cards 200 that are hearts, FIG. 3 shows main cards 200 that are diamonds, FIG. 4 shows main cards 200 that are spades, and FIG. 5 shows main cards 200 that are clubs. In FIGS. 2-5, the full name of the state or territory associated with each main card is listed above the front face of said each card.

In the example shown in FIGS. 2-5, there are fifty-two main cards 200 covering all combinations of the four standard suits and thirteen standard card values. However, there may be more or fewer main cards 200 depending on the number of suits and the number of card values. Furthermore, it is not necessary that the main cards 200 cover all combinations of the suits and card values. Thus, certain card values may only be used for some of the suits.

Each of the main cards 200 is associated with a color. Referring to FIG. 1, the suit 106, card value 108, territorial region 110, and point value 114 may all be displayed in the associated color to enhance visibility. In general, any number of associated colors may be used throughout the deck. In some embodiments, each suit is associated with one of two colors, similar to a conventional deck of playing cards. For example, all of the main cards 200 that are hearts and diamonds may be associated with a first color (e.g., red) while all of the main cards 200 that are clubs and spades are associated with a second color different from the first color (e.g., black).

In some embodiments, all hearts and diamonds are associated with red, which is also the color associated with the Republican party in the United States. Similarly, all clubs and diamonds may be associated with blue, the color associated with the Democratic party in the United States. In some of these embodiments, the territorial regions are assigned to the suits such that each territorial region that voted for a particular political party's nominee in a past presidential election, or that is expected to vote for a particular political party's nominee in a future presidential election, is assigned to a suit having the color associated with the political party. Thus, a first subset of one of more of the plurality of suits is associated with a first political party or its nominee (e.g., the Republican party) while a second subset of all other suits of the plurality of suits is associated with a second political party or its nominee (e.g., the Democratic party).

FIGS. 2-5 shows an example of these embodiments in which all of the states (and the District of Columbia) that voted for the Democratic Party nominee in the 2020 US presidential election are assigned to spades and clubs. Similarly, all of the states that voted for the Republican Party nominee in the same presidential election are assigned to hearts and diamonds. Note that Puerto Rico is a non-voting entity even though it is assigned to diamonds. Thus, it should be understood that there is no hard rule dictating how territorial regions are assigned to suits and colors. Accordingly, the territorial regions may be assigned to card values in a different way without departing from the scope hereof.

In FIGS. 2-5, the territorial regions are assigned to card values in order of their point values. Specifically, higher point values are given higher card values within their assigned subset of suits. For example, in FIGS. 4 and 5, the ace of spades is assigned to California, which has been assigned 54 electoral votes for the 2024 US presidential election (as based on the 2020 US census). This number of electoral votes is the greatest of all the states that voted for the Democratic nominee in the 2020 US presidential election (i.e., Democratic-voting states). The ace of clubs is assigned to New York, which has been assigned 28 electoral votes for the 2024 US presidential election. This number of electoral votes is the second greatest of the Democratic-voting states. The king of spades is assigned to Pennsylvania, which has been assigned 19 electoral votes for the 2024 US presidential election. This number of electoral votes is tied for the third greatest of Democratic-voting states. This pattern continues to Delaware (the 3 of clubs), the District of Columbia (the 2 of spades), and Vermont (the 2 of clubs), which are the Democratic-voting states that have all been assigned the smallest number of electoral votes for the 2024 US presidential election. As shown in FIGS. 2 and 3 for hearts and diamonds, the same pattern also holds for the states that voted for the Republican nominee in the 2020 US presidential election.

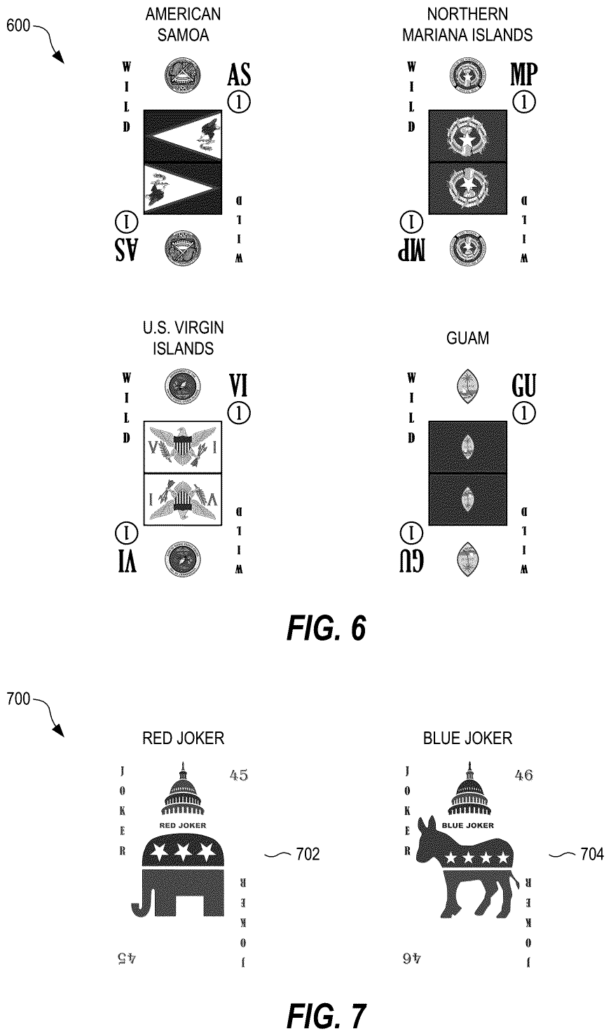

FIG. 6 shows front faces of wild cards 600. The wild cards 600 are not needed for some of the games that can be played with the deck of playing cards. Accordingly, only some of the present embodiments include the wild cards 600. While FIG. 6 shows four wild cards 600, the deck of playing cards may alternatively have more than four, or less than four, wild cards 600.

Each of the wild cards 600 is similar to the main cards 200 of FIGS. 2-5 except that it does not have a card value and suit. As shown in FIG. 6, each of the wild cards 600 may be labeled “WILD” to distinguish it from the main cards 200 (and jokers 700, as discussed below). The wild cards 600 in FIG. 6 have territorial regions corresponding to the non-voting US territories of American Samoa (US Postal Service abbreviation “AS”), the Northern Mariana Islands (US Postal Service abbreviation “MP”), the US Virgin Islands (US Postal Service abbreviation “VI”), and Guam (US Postal Service abbreviation “GU”). Since Puerto Rico (i.e., the eight of diamonds in FIG. 3) is also a non-voting US territory, it may replace any of these territories shown in FIG. 6.

Each of the wild cards 600 is assigned a point value of “1”. However, the wild cards 600 may be alternatively assigned a different point value that is identical to all of the wild cards 600. Alternatively, the wild cards 600 may be assigned a combination of varying point values. The wild cards 600 may be displayed in one or more of the same colors used for the main cards 200 (e.g., red, blue, black, etc.).

FIG. 7 shows front faces of jokers 700. The jokers 700 are not needed in some of the games that can be played with the deck of playing cards. Accordingly, only some of the present embodiments include the jokers 700. In some embodiments, the deck of playing cards includes both the wild cards 600 and jokers 700. In other embodiments, the deck of playing cards includes only the wild cards 600 or only the jokers 700 (but not both). While FIG. 7 shows two jokers 700, the deck of playing cards may alternatively have more than two, or less than two, jokers 700.

Each of the jokers 700 is similar to the main cards 200 of FIGS. 2-5 except that it does not have a card value, suit, territorial region, and point value. As shown in FIG. 7, each of the jokers 700 may be labeled “JOKER” to distinguish it from the main cards 200 and wild cards 600. Each of the jokers 700 may be displayed in one the same colors used for the main cards 200 (e.g., red, blue, black, etc.). In one embodiment, there is one joker for each of the colors used for the main cards 200. For example, in FIG. 7 there is one red joker 702 and one blue joker 704. Based on these colors, the red joker 702 is associated with the Republican party while the blue joker 704 is associated with the Democratic party. The front faces of the jokers 702 and 704 may further display symbols or insignia of their respective political parties. For example, the red joker 702 in FIG. 7 shows an elephant while the blue joker 704 shows a donkey. Each of the jokers 700 may display additional or alternative information without departing from the scope hereof. For example, the red joker 702 in FIG. 7 displays “45” to indicate that the 45^{th} president of the United States was a Republican while the blue joker 704 displays “46” to indicate that the 46^{th} president of the United States was a Democrat.

All of the playing cards in the deck have a similar back face such that it is not possible to identify any playing card only by observing its back face. This includes the main cards 200 of FIGS. 2-5, the wild cards 600 of FIG. 6, and the jokers 700 of FIG. 7. The deck of playing cards may include additional cards without departing from the scope hereof. In this case, the additional cards also have the similar back face so that their identity cannot be determined only by observing the back face.

### White House

The present embodiments include systems and methods for playing games with the playing cards disclosed herein. One such game is called “White House”, a trick-taking game that that can be played as a four-player partnership (i.e., two teams of two players sitting across from each other) or with four individual players. As a trick-taking card game, White House has some similarities with other trick-taking card games known in the art, such as spades, hearts, and bridge. However, these prior-art trick-taking card games all use a standard deck of conventional playing cards. By contrast, White House uses the playing cards of the present embodiments, which includes features not found in a standard deck. Due to these additional features, White House has rules, actions, and methods of play that cannot be implemented with a standard deck of playing cards.

Goal

The goal of White House is to be the first team or player to reach a predetermined set number of election-winning points (e.g., 3, 5, 7, 9, 11, 13, etc.). The larger the number of election-winning points, the longer it takes to finish the game, on average.

Deck of Cards

White House may be played with a deck consisting of the fifty-two main cards 200 shown in FIGS. 2-5 and the two jokers 700 shown in FIG. 7. The wild cards 600 are not used. However, it should be appreciated and understood that White House can be played with a different number of main cards 200, a different number of jokers 700, or no jokers.

Rank of Cards

The playing cards are ranked in increasing order of their card values, similar to conventional playing cards. Aces are high. A tie is broken between playing cards of the same color by their electoral votes. If the electoral votes of two playing cards are the same, then the high card is the card that was played first. For example, the King of hearts (Ohio: 17 electoral votes) beats the King of diamonds (North Carolina: 16 electoral votes). In another example, the Queen of hearts (Tennessee: 11 electoral votes) beats the Queen of diamonds (Indiana: 11 electoral votes) when it is played before the Queen of diamonds. When the Queen of diamonds is played before the Queen of hearts, it beats the Queen of hearts.

Jokers

The two jokers 700 are named “Big Joker” and “Little Joker”. The Big Joker is always the same color as trump (i.e., either red or blue). The Little Joker is the color that is not trump. For example, if a red suit (i.e., hearts or diamonds) is trump, then the red joker 702 is the Big Joker and the blue joker 704 is the Little Joker. Alternatively, if a blue suit (i.e., spades or clubs) is trump, then the blue joker 704 is the Big Joker and the red joker 702 is the Little Joker. The Big Joker beats the Little Joker. All jokers 700 are frump, regardless of color. Furthermore, any joker beats all other trump cards (i.e., main cards 200 of the trump suit).

Partnership Play

In partnership play, partners sit across from each other, thereby forming two teams. For each hand of play, the objective of the bidding team (see section titled “Bidding” below) is to win at least the number of electoral votes that they bid. Electoral votes are counted by adding the electoral votes displayed on the playing cards (i.e., see the point value 114 in FIG. 1) won by the bidding team. The objective of the other team is to prevent the bidding team from reaching the number of electoral votes that was bid.

Dealing

In one embodiment, the first dealer is chosen by a draw for high card. Alternatively, the first dealer is chosen differently (e.g., randomly, by a draw for low card, etc.). To set up for the deal, the deck, including the two jokers, is shuffled. Each player receives twelve playing cards for a total of forty-eight cards dealt. The remaining six playing cards make up a kitty that will be the first trick won by the bidding team.

The entire deck is dealt one-card-at-a-time, face down, beginning on the dealer's left. In some embodiments, some of the playing cards are excluded from the kitty while dealing, and therefore must be dealt to a player. For example, the first four playing cards and the last four cards of the deck may be excluded from the kitty. However, a different number of playing cards at the beginning and end of the deck may be excluded from the kitty. The number of excluded cards at the beginning of the deck need not equal the number of excluded cards at the end of the deck. In one embodiment, no cards are excluded from the kitty.

Bidding

After the deck has been dealt and the kitty has been created, the bidding phase of the game commences. The player to the dealer's left starts the bidding. Each player in turn states a bid for their team. Each player decides how many electoral votes their team will be able to take from all of the tricks their team wins by the end of the hand. There is only one round of bidding.

In one embodiment, there is a minimum bid of 270 (i.e., equal to the number of electoral votes that a US presidential nominee needs to win to be elected president). In other embodiments, a different value of the minimum bid is used. A player may either raise the highest bid or pass. The dealer must accept the minimum bid (e.g., 270) when all of the other players pass. A player may raise the bid by a fixed increment (e.g., 5, 10, 20, etc.). For example, the first bidder bids 270, the second bidder passes, the third bidder bids 300, and then the dealer (i.e., the fourth player) bids 310. The player who placed the highest bid during the bidding phase is the “winning bidder”. The winning bidder's team is referred to as the “bidding team”.

Declaring Trump

The winning bidder declares a trump suit before viewing the playing cards in the kitty. The trump suit can be any of the plurality of suits. A blue bid is when the trump suit is spades or clubs. A red bid is when the trump suit is hearts or diamonds.

Kitty

After trump is declared, the winning bidder picks up the six-card kitty and may exchange any playing card in their dealt hand for a playing card in the kitty. The playing cards that the winning bidder discards back into the kitty can come from the winning bidder's dealt hand, the original kitty, or a combination thereof. The six playing cards which are discarded are placed face down in front of the winning bidder and count as the first trick won by the bidding team. In one embodiment, the winning bidder forfeits the hand and loses the bid if, after the start of play, the kitty does not have six playing cards or the bidder winner does not have twelve playing cards in their hand.

Play

The player on the dealer's left may begin the first round of play by “leading”, i.e., placing a playing card from their hand face up in front of all the players. Alternatively, the winning bidder may lead when the winning bidder is not the player on the dealer's left. Regardless of who leads, play always continues in the same direction (e.g., clockwise) with each player in turn placing one of their playing cards face up. After each player has played one card, there are four playing cards in the middle. These four cards are the “trick”. The trick is won by the player who played the highest playing card in the trick. The player who won the trick may then lead the next round of play. After twelve rounds, all four players have no cards left in their hand.

A trump card in a trick always beats (i.e., is higher than) all non-trump cards in the trick. If there is more than one trump card in the trick, then the highest-ranking trump card wins (i.e., the highest-ranking trump card is the highest card in the trick). If there is no trump card in the trick, then the highest-ranking card of the suit that was led wins.

In some embodiments, a player cannot lead with a trump card unless the player's hand only includes playing cards of the trump suit. A player must follow the suit played, if possible. If the player cannot follow the suit played, then the player may play a trump card or a playing card of another suit. After a trump card has been played, any player may subsequently lead with a trump card. This is the point at which trump has been “broken”. A player can also break trump by playing a trump card when there is no other option.

A renege occurs when a player fails to follow the suit led even though he or she has a card of that suit in their hand. In some embodiments, a team caught reneging is penalized for reneging. For example, the team may be forced to forfeit the hand and the electoral votes equivalent to winning the bid are awarded to the other team.

Scoring

Each team begins with a score of zero election-winning points. At the end of each hand of play, the bidding team either wins or loses some election-winning points. After the hand, the bidding team counts the number of electoral votes in all tricks won by the two players of this team, including the electoral votes in the kitty. If the number of electoral votes is greater than or equal to the amount that was bid, then the bidding team has won the “White House” and receives one or more election-winning points. The number of election-winning points received may be based on the trump suit or its color. For example, the bidding team may receive one election-winning point for a blue bid or two election-winning points for a red bid. If the number of electoral votes is less than the amount that was bid, then the bidding team loses one or more election-winning points. The number of election-winning points lost may be based on the trump suit or its color. For example, the bidding team may lose two election-winning points for a blue bid or one election-winning point for a red bid.

In some embodiments, the game ends in one hand when the bidding team bids a landslide. For example, the landslide may be 500 electoral votes, or more. Winning the hand with a landslide bid automatically wins the game regardless of the current score.

Bidding Variation

In one embodiment, the two teams elect to mutually agree to bid for a particular trump suit throughout the duration of the game. For example, the first team may elect to always bid a red suit as trump (i.e., hearts or diamonds) while the second team elects to always bid a blue suit as trump (i.e., spades or clubs). This bidding variation sets up a fun competition between a “Red Team” and a “Blue Team”.

Individual Play

In other embodiments, White House is played with four individual players rather than teams or partnerships. Each of the four players both plays and scores for himself or herself (i.e., without any partner). Each player individually competes by bidding and winning tricks. Individual play is the same as partnership play, as described above, with the following changes.

In some embodiments, after the winning bidder has declared trump and before the winning bidder leads the first round of play, the other three players can register a challenge to defeat the bid. Any player who challenges the bid will receive a bonus (e.g., receives one election-winning point) if the bid is defeated or penalty (e.g., loses one election-winning point) if it is not.

In some embodiments, the winning bidder leads the first round of play. Any playing card may be led, and the other players must follow the suit that was led, if they have it in their hand. Trump need not be broken.

At the end of each hand of play, the winning bidder's score changes the same as in partnership play. In addition, any individual player that registered a challenge to defeat the bid is awarded the bonus if the challenge was successful or penalty if it was not. The game continues with additional hands of play until (i) one player reaches the set number of election-winning points or the negative equivalent and (ii) there is no tie between the highest players.

In some embodiments, the winning bidder of a hand automatically wins the game by bidding a landslide (e.g., 400 electoral votes or more) and then making the bid.

### Statehood

Another game that can be played with the playing cards disclosed herein is called “Statehood”, which is an individual point-scoring game for two to four players.

Deck of Cards

Statehood may be played with a deck consisting of the fifty-two main cards 200 shown in FIGS. 2-5 and the four wild cards 600 shown in FIG. 6. The jokers 700 are not used. However, it should be appreciated and understood that Statehood can be played with a different number of main cards 200, a different number of wild cards 600, or both.

Objective

The objective of Statehood is to earn points by declaring statehood for the District of Columbia (DC), Puerto Rico (i.e., the eight of diamonds in FIG. 3), and the U.S. overseas territories represented by the wild cards 600 of FIG. 6 (i.e., American Samoa, Guam, the Northern Mariana Islands, and the US Virgin Islands). Other players may challenge statehood declarations, either to steal points or other strategic reasons. The winner of the game is the first player to reach a predetermined number of points (e.g., 56) with the highest point tally and not tied for the lead with another player.

Rank of Cards

The playing cards are ranked according to the order of their card values (see the card value 108 in FIG. 1). Aces are high. A tie between two playing cards is broken by the number of electoral college votes. For example, the King of hearts (Ohio: 17 electoral votes) beats the King of diamonds (North Carolina: 16 electoral votes).

Dealing

The first dealer may be chosen by a draw for high card. Alternatively, the first dealer may be chosen in another way (e.g., random, draw for low card, etc.). The deck (i.e., the main cards 200 and the wild cards 600) is shuffled, after which each player is dealt seven playing cards. The remaining playing cards are placed in the center of the table, face down, to form a draw pile. The top playing card of the draw pile is placed face up to start a discard pile adjacent to the draw pile. If this top playing card is Puerto Rico, the hand ends. After each hand, the deal passes to the left.

Player Turns

One player (e.g., the player to the dealer's left) starts the hand. A player chooses from one of three options for each turn. First, the player may swap the top playing card in the discard pile with one from their hand. Second, the player may draw the top playing card off the draw pile. The player then either discards the drawn card or adds it to their hand. In the latter case, the player must discard one playing card from their hand, placing it face up in the discard pile so that they continue to have only seven playing cards in their hand. Third, the player may declare statehood for a wild card, DC, or Puerto Rico.

After the first turn, play continues in order (e.g., clockwise) until the draw pile has no cards remaining or a player uses their turn to declare statehood for Puerto Rico. Declaring statehood for Puerto Rico ends the hand. Any playing card, except for Puerto Rico, may be placed in the discard pile. A player who discards Puerto Rico, whether purposefully or mistakenly, forfeits the hand. In this case, the hand is over and each of the remaining players may receive a fixed number of points (e.g., four or six).

Declaring Statehood

A declaration of statehood for a wild card is called a “wild-card declaration”. For a wild-card declaration to be valid, the player making the declaration places the wild card face up with one other playing card used to defend the declaration. Thus, the player making the wild-card declaration must have both the wild card and the defending card in their hand. The defending card for a wild-card declaration may be any playing card except Puerto Rico. The defending card's value is based on its electoral votes. For example, the US Virgin Islands may be defended by Georgia (i.e., the Queen of spades), which has sixteen electoral votes.

A declaration of statehood for DC is called a “DC declaration”. For a DC declaration to be valid, the player making the declaration places the DC playing card face up along with one, two, or three other playing cards to defend it. Thus, the player making the DC declaration must have both the wild card and the one or more defending cards in their hand. In one embodiment, the defending one or more cards for a DC declaration must be from a blue-colored suit (i.e., spades or clubs). For example, DC can be defended by Colorado (eight of clubs), Virginia (Jack of clubs), and California (Ace of spades). The total number of electoral votes of these three defending cards is 77.

A declaration of statehood for Puerto Rico is called a “Puerto Rico declaration”. As mentioned above, a Puerto Rico declaration ends the hand. The player making the Puerto Rico declaration lays their entire hand face up. The Puerto Rico declaration is defended by the sum of the electoral votes of all other playing cards in the player's hand. In one embodiment, the defending cards are from any suit. Thus, in this example the Puerto Rico declaration is always defended by six playing cards.

Challenging Statehood

Any player may challenge a declaration of statehood by putting forth one or more challenging cards. For example, the player may put forth one challenging card for a wild-card declaration, one to three challenging cards for a DC declaration, or six challenging cards for a Puerto Rico declaration. However, other numbers of challenging cards may be used. In any case, the sum of the electoral votes of the one or more challenging cards must exceed the sum of the electoral votes of the defending cards.

In some embodiments, a player making a DC declaration can only defend with blue-suited playing cards (i.e., spades, or clubs). A player challenging the DC declaration can only do so with red-suited playing cards (i.e., hearts or diamonds). Puerto Rico cannot be used to defend or challenge.

A challenge to a wild-card or DC declaration starts to the left of the player who made the declaration. A player may either challenge the declaration or pass. If passing, the next subsequent player is presented with the same option, and so on, until each player has had one chance to either challenge the declaration or pass.

Each player in turn can only challenge once and must challenge with more electoral votes than the proceeding player. The player with the highest electoral vote count wins the challenge. For example, consider a player who declares statehood for the US Virgin Islands, defending it with one playing card having ten electoral votes. The second player challenges the declaration with one playing card having eleven electoral votes, the third player passes, and the last player challenges the declaration with one playing card having twelve electoral votes. In this example, the last player wins the challenge and receives a bonus (e.g., one point) for the US Virgin Islands.

The player that wins a challenge is awarded the associated playing card along with all of the challenging and defending cards that were considering for the challenge.

After all challenges are done, each challenger draws more playing cards from the draw pile to restore their hand to seven playing cards. The player that declared statehood draws last. Once all hands are restored, play continues in order (e.g., clockwise). If there are not enough playing cards in the draw pile to restore all of the players' hands, then after the last playing card is drawn, the player holding Puerto Rico must declare statehood for it.

The hand ends when a player declares statehood for Puerto Rico. Each of the other players lays down six cards to challenge the declaration. The successful challenger with the most electoral votes receives points (e.g., six points). If there are no successful challenges, the player that declared statehood for Puerto Rico receives these points. In one embodiment, the player that declared statehood for Puerto Rico receives additional points for wild cards and DC held by unsuccessful challengers.

Play

After playing cards are dealt to begin the game, the player to the dealer's left takes the first turn. When a statehood declaration is made, each of the other players decides whether or not to challenge the declaration. If unchallenged, the player making the declaration receives points. If challenged, then the winner of the challenge receives points. Each player who challenged draws additional playing cards from the draw hand to restore their hand. The player who made the statehood declaration draws last. Then the next player begins their turn.

The hand continues with players taking turns in order (e.g., clockwise) until a player declares statehood for Puerto Rico. A player holding Puerto Rico must declare statehood for Puerto Rico after any player takes the last playing card from the draw pile and subsequently discards. After all challenges to the Puerto Rico declaration have been considered, the hand ends and points are tallied.

Scoring

Each player begins the game with a score of zero. At the end of each hand, players tally points for successful statehood declarations and challenges. In one embodiment, each wild card is worth one point, DC is worth three points, and Puerto Rico is worth six points. However, other point values may be used.

The winner is the first player to reach a predetermined number of points (e.g., 56) with the highest point tally and not tied for the lead with another player. Increasing the predetermined number of points lengthens the game while decreasing this predetermined number shortens the game.

### Electronic Embodiments

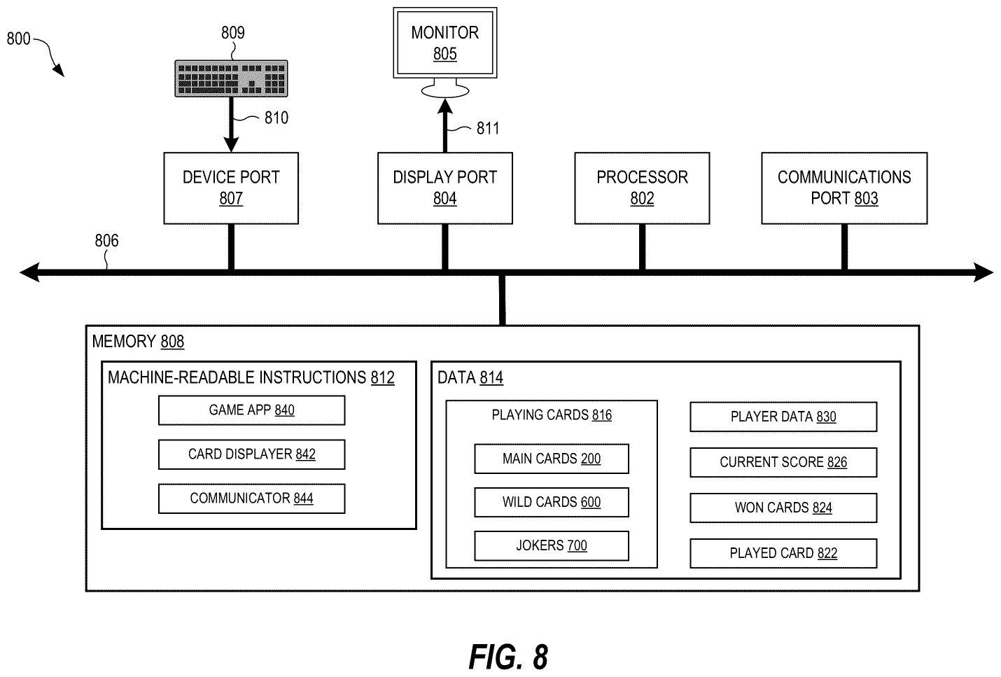

FIG. 8 is a functional diagram of a computing device 800 that electronically implements playing cards of the present embodiments. The computing device 800 may also implement one or more of the game of White House, the game of Statehood, and any other game playable with the playing cards disclosed herein. In FIG. 8, the computing device 800 is shown as a personal computer (e.g., a desktop). Other examples of the computing device 800 include, but are not limited to, a laptop computer, a mobile device (e.g., a smart phone), a handheld computer, a tablet computer, and a video-game system (e.g., a handheld or home video game console).

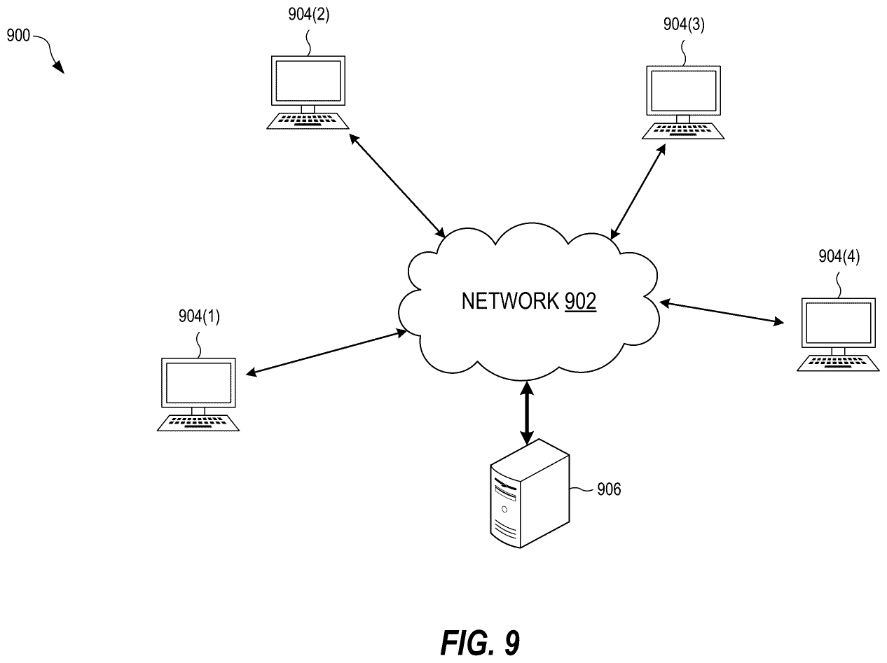

The computing device 800 has a processor 802, a memory 808, a display port 804 for communicating information 811 to a monitor 805, a device port 807 for receiving instructions 810 from a keyboard 809, and a communications port 803 with which the computing device 800 can communicate with other computing devices (see FIG. 9). The processor 802, memory 808, display port 804, device port 807, and communications port 803 communicate with each other over a system bus 806. Although not shown in FIG. 8, the computing device 800 may include other components (e.g., hard disk drive, solid-state drive, external memory storage, media drive, etc.) without departing from the scope hereof.

The memory 808 may be volatile RAM located proximate to the processor 802. While the monitor 805 is shown in FIG. 8 as an LCD monitor, the monitor 805 may alternatively be a television, touchscreen, or other type of device capable of graphically displaying the information 811 to a user. The computing device 800 may also operate with more than one monitor. While FIG. 8 shows the computing device 800 receiving instructions 810 from the keyboard 809, the computing device 800 may alternatively or additionally receive instructions 810 from one or more other types of user input devices. Examples of such user input devices include, but are not limited to, a mouse, trackpad, joystick, game controller, touchscreen, and stylus.

The communications port 803 may implement a wired network interface (e.g., Ethernet, Infiniband, Fibre Channel, etc.), a wireless network interface (e.g., WiFi, Bluetooth, BLE, etc.), a cellular network interface (e.g., 4G, 5G, LTE), an optical network interface (e.g., SONET, SDH, IrDA, etc.), a multi-media card interface (e.g., SD card, Compact Flash, etc.), or another type of communication port through which the computing device 800 can communicate with another remote device. While FIG. 8 shows the computing device 800 with only one communications port 803, the computing device 800 may alternatively have more than one communications port 803 such that the computing device 800 can communicate with multiple remote devices over more than one network.

The processor 802 may be any type of circuit that can perform logic, control, and input/output operations. For example, the processor 802 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC). The processor 802 may also include a memory controller, bus controller, and other components that manage data flow between the processor 802, memory 808, and other components connected to the system bus 806.

The memory 808 stores machine-readable instructions 812 that, when executed by the processor 802, control the computing device 800 to implement the functionality described above. The memory 808 also stores data 814 used by the processor 802 when executing the machine-readable instructions 812. The machine-readable instructions 812 and data 814 may be used to enforce and implement rules for any game played with the playing cards of the present embodiments.

In the example of FIG. 8, the data 814 includes an array, table, or list of playing cards 816. The playing cards 816 may include the main cards 200 of FIGS. 2-5, the wild cards 600 of FIG. 6, the jokers 700 of FIG. 7, or any combination thereof. The data 814 also includes player data 830, such as identifying information (e.g., a name, email address, etc.) of a local user playing a game with the computing device 800. The player data 830 may also include identifying information of other players (e.g., names, IP addresses of other computing devices that communicate with the computing device 800, etc.). The data 814 also includes a current score 826, which may be the score of the local user. The current score 826 may also include the scores of remote users. The data 814 also includes won cards 824, such as the identity of the playing cards in all tricks won by the user (e.g., in the current hand of play). The data 814 also includes a played playing card 822. The memory 808 may store additional data 814 than shown in FIG. 8 without departing from the scope hereof.

In the example of FIG. 8, the machine-readable instructions 812 include a game application, or game app 840, that is executed by the user to play a game with the playing cards 816 (e.g., the game of Statehood or the game of White House). The game app 840 may call a card displayer 842 that displays one or more of the playing cards 816 on the monitor 805. The game app 840 may also call a communicator 844 that receives or transfers information via the communications port 803. The memory 808 may store additional machine-readable instructions 812 than shown in FIG. 8 without departing from the scope hereof.

In one embodiment, the computing device 800 implements a single-player “solitaire” version of a multi-player game that can be played with the playing cards 816. Advantageously, these solitaire games can be played without any network communication with other computing devices. Accordingly, solitaire games are particularly useful when the computing device 800 cannot access a computer network (e.g., no cellular or Wi-Fi connectivity).

In one embodiment, the computing device 800 implements a solitaire version of White House. In this embodiment, the user “plays” with three other fictitious players. The computing device 800 may use a random-number generator to at least partly determine how playing cards are dealt to the user and the three fictitious players. The random-number generator may also be used to determine how the fictitious players bid and play their hands. In another embodiment, the computing device 800 implements a solitaire version of Statehood. In this embodiment, the user “plays” with one, two, or three other fictitious players. Again, a random-number generator may be used to at least partly determine behavior of the fictitious players.

FIG. 9 is a functional diagram of a networked computer system 900 that electronically implements playing cards of the present embodiments. The networked computer system 900 may also be used to implement multi-player versions of one or more of the game of White House, the game of Statehood, and any other multi-player game playable with the playing cards of the present embodiments. In the networked computer system 900, a first player uses a first computing device 904(1), a second player uses a second computing device 904(2), and a third player uses a third computing device 904(3), and a fourth player uses a fourth computing device 904(4). Each of the computing devices 904(1)-904(4) is an example of the computing device 800 of FIG. 8. The computing devices 904(1)-904(4) are remote from each other and communicate with each other via a communications network 902. The network 902 may be private or public. Examples of the network 902 include, but are not limited to, a local area network, a personal area network, a wide area network, and a network of network (e.g., the Internet).

In some embodiments, the computing devices 904(1)-904(4) cooperate with each other to implement the multi-player game. In one of these embodiments, the multi-player game is White House (either partnership play or individual play). In another of these embodiments, the multi-player game is Statehood. In other embodiments, the networked computer system 900 includes a server 906 that communicates, via the network 902 with the computing devices 904(1)-904(4). In these embodiments, the server 906 cooperates with the computing devices 904(1)-904(4) to implement the multi-player game. For example, the server 906 may host a website that each of two or more users accesses with their respective computing device 904. After logging on to the website, the users may then play the multi-player game with each other, using the server 906 to implement rules of the game and track moves by the various players.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A deck of playing cards, comprising:
a plurality of main cards having an identical rear face, each main card of the plurality of main cards having a front face that indicates:
a card value selected from a plurality of card values;
a suit selected of a plurality of suits;
a territorial region selected from a plurality of territorial regions; and
a point value;
wherein (i) the combination of the card value and the suit uniquely identifies said each main card among the plurality of main cards and (ii) the territorial region uniquely identifies said each main card among the plurality of main cards.

2. The deck of playing cards of claim 1, the plurality of territorial regions comprising the fifty states of the United States of America, the District of Columbia, and at least one United States overseas territory.

3. The deck of playing cards of claim 2, the point value equaling a number of electoral-college votes either cast by the territorial region or allocated to the territorial region when the territorial region is one of the fifty states or the District of Columbia.

4. The deck of playing cards of claim 3, the number of electoral-college votes equaling the number of electoral-college votes allocated to the territorial region for the 2024 US presidential election.

5. The deck of playing cards of claim 1, each of the plurality of suits being displayed in a color.

6. The deck of playing cards of claim 5, wherein:
one or more of the plurality of suits are displayed in a first color; and
all others of the plurality of suits are displayed in a second color that is different than the first color.

7. The deck of playing cards of claim 6, the first color being red and the second color being blue.

8. The deck of playing cards of claim 1, wherein:
the plurality of territorial regions comprise the fifty states of the United States of America, the District of Columbia, and at least one United States overseas territory;
a first subset of one of more of the plurality of suits is associated with a Republican presidential nominee;
for each main card whose territorial region voted for the Republican presidential nominee, the suit of said each main card is selected from the first subset;
a second subset of all other suits of the plurality of suits is associated with a Democratic presidential nominee; and
for each main card whose territorial region voted for the Democratic presidential nominee, the suit of said each main card is selected from the second subset.

9. The deck of playing cards of claim 8, wherein:
the first subset consists of clubs and spades; and
the second subset consists of hearts and diamonds.

10. The deck of playing cards of claim 8, the main cards of each of the plurality of suits having card values being ordered based on their point values.

11. The deck of playing cards of claim 1, said each main card further indicating, on its front face, information about the territorial region of said each main card.

12. The deck of playing cards of claim 11, the information including one or more of: an insignia, a color, a flag, a seal, a coat of arms, a founding date, a motto, a nickname, flora, fauna, a bird, a dance, a poem, a food, a license plate, a musical instrument, a sport, a toy, a quarter, a tartan, demographic information, historical information, geographic information, and government information.

13. The deck of playing cards of claim 1, further comprising a plurality of wild cards having the identical rear face, each wild card of the plurality of wild cards having a front face that indicates:
a territorial region that is not indicated on any of the plurality of main cards; and
a point value.

14. The deck of playing cards of claim 13, said each wild card further indicating, on its front face, information about the territorial region of said each wild card.

15. The deck of playing cards of claim 1, further comprising a plurality of jokers having the identical rear face.

16. The deck of playing cards of claim 15, the plurality of jokers comprising two jokers of different colors.

17. The deck of playing cards of claim 1, the plurality of main cards including all combinations of the plurality of suits and the plurality of card values.

18. The deck of playing cards of claim 1, wherein:
the plurality of suits consist of spades, clubs, hearts, and diamonds; and
the plurality of card values consist of 2, 3, 4, 5, 6, 7, 8, 9, 10, Jack, Queen, King, and Ace.

19. The deck of playing cards of claim 1, a number of the plurality of main cards equaling fifty-two.

20. A computing device comprising:
a processor;
a memory in electronic communication with the processor; and
a graphical display in communication with the processor;
the memory storing machine-readable instructions that, when executed by the processor, control the computing device to display, on the graphical display, an image of one or more of the plurality of main cards of the deck of playing cards of claim 1.
